(19) United States
(12) Patent Application Publication
(10) Pub. No.: US 2016/0016132 A1
(43) Pub. Date: Jan. 21, 2016

(54) VERTICAL SCREW FEED MIXER WITH GUIDE PADDLE

(71) Applicant: Patz Corporation, Pound, WI (US)

(72) Inventors: Robert J. Buresh, Northfield, MN (US); David C. Pellman, Coleman, WI (US)

(73) Assignee: Patz Corporation, Pound, WI (US)

(21) Appl. No.: 14/695,810

(22) Filed: Apr. 24, 2015

Related U.S. Application Data
(60) Provisional application No. 61/995,950, filed on Apr. 25, 2014.

(51) Int. Cl. B01F 7/16; B01F 3/18; B01F 3/12; B01F 7/24

(52) U.S. Cl. CPC B01F 7/162; B01F 7/24; B01F 3/18; B01F 3/1221; B01F 2215/0008

(57) ABSTRACT

A feed mixer with a vertical screw and one or more paddles that enhance mixing efficiency. Each of the paddles has a guide portion that extends below the flighting on the screw, and an attachment portion by which the paddle is connected to the screw. During rotation of the screw, the paddle both draws new material inward onto the flighting and helps retain material on the flighting.

### CROSS REFERENCE TO RELATED APPLICATION

This application claims the benefit of U.S. Provisional Patent Application No. 61/995,950, filed Apr. 25, 2014. All of the information disclosed in that application is hereby incorporated herein by reference in its entirety.

### FIELD OF THE INVENTION

The present invention relates to vertical screw feed mixers, and more particularly, to structures for improving the mixing in a vertical screw mixer.

### BACKGROUND OF THE INVENTION

Feed mixers are commonly used for a number of purposes, but primarily for preparing feed mixtures for dairy and beef cattle. A livestock feed mixture may contain many components, including but not limited to: alfalfa, grass, corn stalks, straw, by-products from ethanol production, liquid whey, silage, grains, hay, vitamins, and minerals. Additionally, water may be added to improve moisture content. Ideally, the mix should be fed to the livestock as a uniform substance. Nutrients and other components should be uniformly distributed within the feed. Effective as current feed mixers are, there is a need for further improvement in mixing technology.

Referring to FIG. 1, vertically oriented feed mixers employ one or more vertically oriented screws or augers 1. FIG. 1 shows a side view of a vertically oriented feed mixer 30 with screw 1. FIG. 2 shows a top view of the screw 1. FIG. 3 shows a perspective view of screw 1. The rotation of the screw 1 is shown in FIG. 2, by arrow 2. The screw 1 has a central core 10 and a continuous spiraling extension 20, which may also be referred to as a flighting. It will be appreciated that the screw 1 will rotate in either of two directions depending on the orientation of the flighting 20, or conversely, the orientation of the flighting may be determined by the direction of rotation of the screw. Screws with more than one flighting are also known in the art. The spiraling extension or flighting 20 has a continuous upper surface 22, which may be referred to herein as a deck, and a continuous lower surface 24. The spiraling extension 20 has a leading lower edge 26 and a trailing upper edge 28, and an outer edge 29. The spiraling extension 20 typically tapers from the lower edge to the upper edge, though flightings without such tapering or with different taperings are sometimes employed. Often there is more than 540 degrees of rotation between the leading edge 26 and the trailing edge 28, but many screws have less rotation as well.

It is known in the art that the screw 1 may also include or define sets of holes or apertures 80 near the outer edge 29 of the flighting 20. The holes 80 are generally used for attaching accessories such as knives. See e.g. United States patent publication 20130284841,which is hereby incorporated by reference. A set of holes on the screw 1 may be referred to herein as a flighting attachment point 80. As shown in FIG. 2, screw 1 may have a plurality of flighting attachment points 80 at different locations along the edge of the flighting 20.

Besides one or more screws, a vertically oriented mixer further comprises a mixing chamber 70 or hopper formed by a bottom wall 75 and a side wall 76. The side wall has an inner surface 77 and an outer surface 78.

The basic mixing principle of a feed mixer is repeatedly tumbling the feed materials to be mixed into a cavity. The screw or screws 1 lift material and create a cavity for this material to tumble into. As the screw 1 rotates, the leading edge 26 lifts materials from the bottom of the mixer 75. These materials travel upwards above the upper surface of the flighting 20. A cavity 40 is created under the spiraling extension behind leading edge 26 during rotation. As the material is lifted, it tends to fall off the outer edge 29 down towards the cavity 40.

If the materials lifted from the bottom 75 of the mixer fall off the outer edge 29 too soon, the mixing is inefficient. It is desirable that the material coming off the upper edge 28 is mostly the same material lifted from bottom of the mixer 75. One known method of improving this aspect of mixing is to incline the spiraling extension horizontally from the central core 10 to the outer edge 29. This structure is described in United States Patent Publication No. 20140036619, which is hereby incorporated by reference.

This invention relates to improvements to the structures described above, and to solutions to some of the problems raised or not solved thereby.

### SUMMARY OF THE INVENTION

The invention provides a feed mixer with a vertically oriented screw, and a paddle mounted to the screw to enhance mixing efficiency in the mixer. One or more such paddles extend below the flighting. During rotation of the screw, the paddle both draws new material inward onto the flighting deck and also helps retain material on the flighting deck.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a side view of a vertically oriented mixer with screw.

FIG. 2 shows a top view of the screw shown in FIG. 1.

FIG. 3 shows a perspective view of the screw shown in FIG. 1.

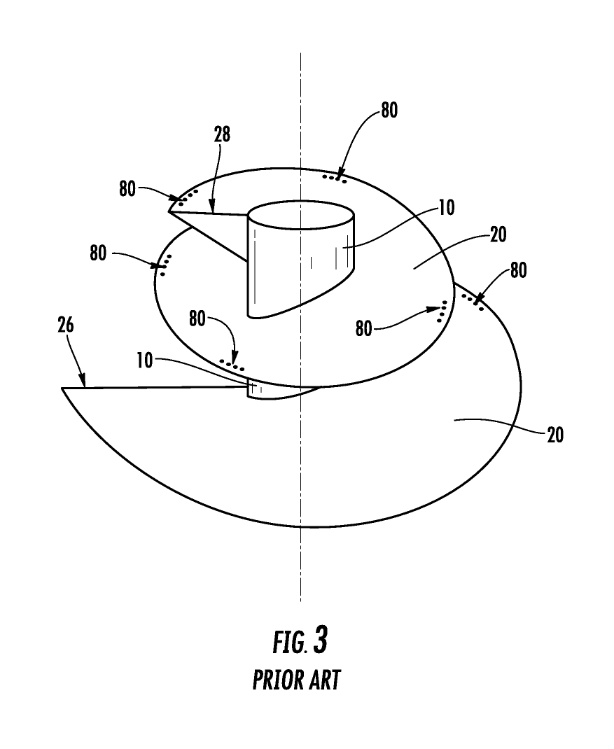

FIG. 4 shows a perspective view of a paddle constructed according to one embodiment of the present invention.

FIG. 5 shows a side view of a screw with a first paddle attached according to one embodiment of the present invention.

FIG. 6 is an end view of a paddle constructed according to one embodiment of the present invention.

FIG. 7 is an end view of a paddle constructed according to another embodiment of the present invention.

FIG. 8 shows a top view of a screw with a first paddle attached.

FIGS. 9 and 10 are enlarged partial top views of a portion of a screw with a paddle attached.

FIG. 11 is a perspective view showing of a screw with multiple paddles attached thereto.

FIG. 12 is a side view of a paddle constructed according to an alternative embodiment of the invention and attached to a screw.

FIGS. 13A through 13E are various views of another alternative embodiment of a paddle according to the invention, including FIG. 13E showing the paddle attached to a screw.

FIGS. 14A through 14G are various views of still another alternative embodiment of a paddle according to the invention, including FIGS. 14E through 14G showing the paddle attached to a screw in different positions.

FIGS. 15A through 15E are various views of yet another alternative embodiment of a paddle according to the invention, including FIG. 15E showing the paddle attached to a screw.

FIGS. 16A through 16E are various views of another alternative embodiment of a paddle according to the invention, including FIG. 16E showing the paddle attached to a screw.

FIGS. 17A through 17E are various views of another alternative embodiment of a paddle according to the invention, including FIG. 17E showing the paddle attached to a screw.

### DETAILED DESCRIPTION

Embodiments of the present invention are described herein in the context of a paddle to improve feed mixing in a feed mixer. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-specific and business-related constraints, and that these specific goals will vary from one implementation to another and from one developer to another.

The invention provides a paddle 100 for use in a vertical screw mixer that helps keep material lifted off the bottom of the mixer on the upper surface or deck 22 of the flighting 20 until it falls off the flighting at the upper edge 28. The paddle 100 continually pulls material inward towards the central core 10 as the screw 1 rotates. This action tends to avoid a situation where too much material is falling off the outer edge 29 of the flighting 22 during the mixing process. Paddle 100 may also be considered to retain or hold the material from being thrown off the deck 22 due to the centrifugal force of the spinning screw.

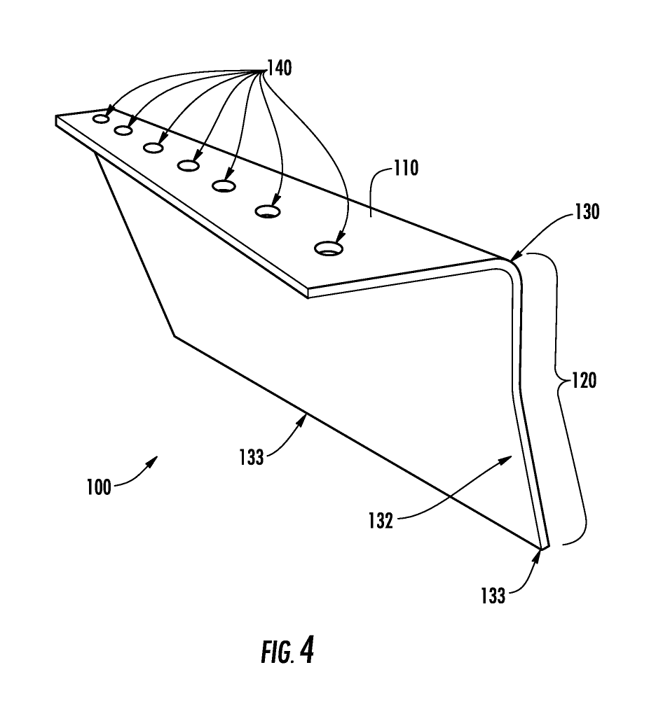

FIG. 4 depicts a perspective view of a paddle 100 constructed according to a preferred embodiment of the present invention. Paddle 100 is formed of an attachment portion 110, for attachment of the paddle to the flighting 20 near the outer edge 29 of the flighting. As shown in this figure, attachment portion 110 of paddle 100 is oriented generally horizontally in respect to the flighting 20 at the attachment point 80. However, since a simple flighting will most likely spiral at an angle, and a doubly inclined flighting has an additional tilt, the attachment portion 110 may not be entirely horizontal with respect to the ground. Extending downward in the figure from attachment portion 110 is a guide portion 120. The guide portion 120 has an upper corner edge 130, a leading edge 132, and a lower edge 133. The guide portion 120 may be integrally formed with, or separately formed and attached to, attachment portion 110. Attachment portion 110 includes a series of holes or apertures 140 for use in bolting the paddle 100 to the screw 1. Preferably, there are more holes 140 in the paddle 100 than necessary for secure attachment of the paddle to the screw 1, so that the position of the paddle on the screw may be adjusted, for optimal performance as described below.

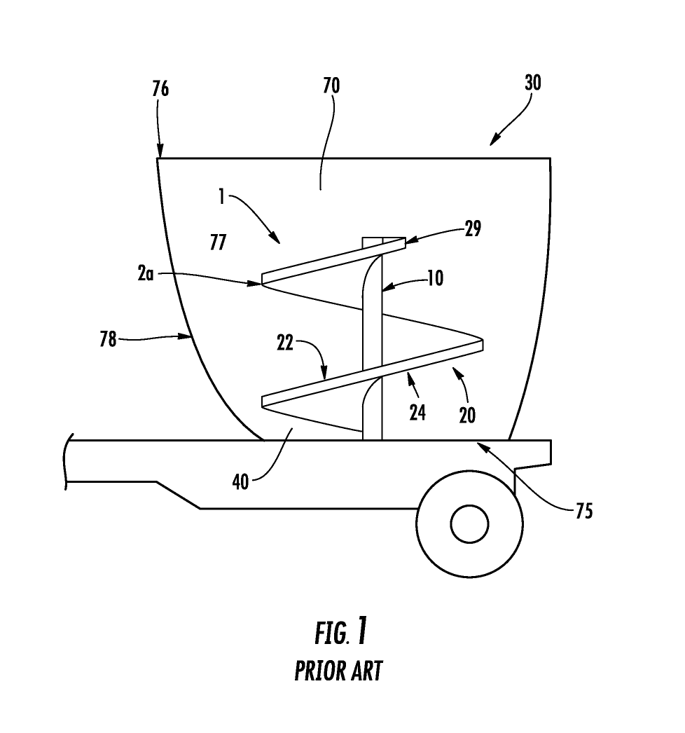

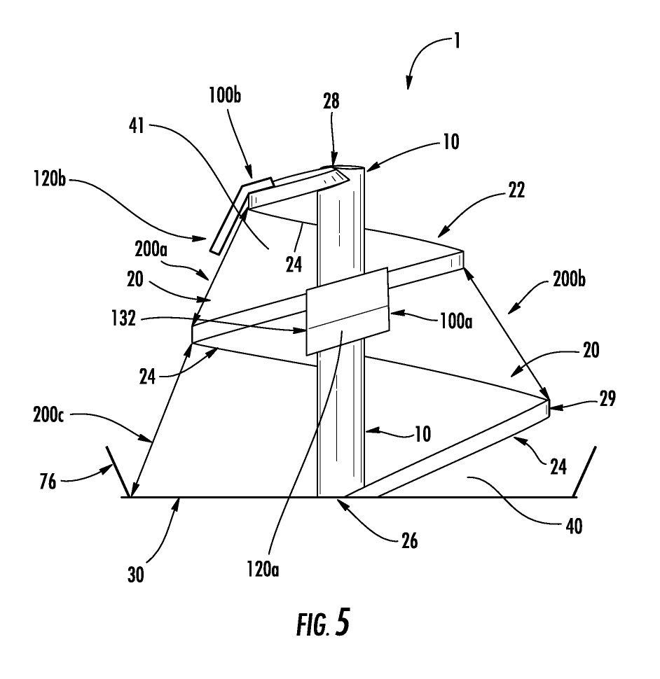

FIG. 5 shows a side view (reverse relative to FIG. 1) of a screw 1 with first and second paddles 100a and 100b attached. First paddle 100a and second paddle 100b are shown attached to flighting 20 of screw 1. The assembly is effective in improving mixing efficiency because the hopper is typically filled with material over the top of the screw. Leading paddle edge 132 is oriented in the same direction as leading flighting edge 26 with respect to rotation of the screw. While a cavity 40 forms behind the leading screw edge 26 of the flighting 20 as the screw 1 rotates, the rest of the area around the screw is filled with materials to be mixed. As the screw 1 rotates, the cavity continually moves and is backfilled. Optimal mixing requires efficient transport of materials from the bottom of the hopper to the top. The paddle 100 aids this transport by keeping material on the deck 22 of the flighting 20, as well as drawing in new material. This is achieved by guide portion 120a of the first paddle arm 100a channeling material so it stays on the flighting deck 22 as the screw 1 rotates.

FIG. 5 illustrates the concepts of clearance distance and partial channels on a vertical screw. Clearance distance 200a, 200b, 200c is the distance between the bottom of the outer edge 29 of the flighting 20 and the outer edge of the flighting below it (as in 200a and 200b), or the distance between the bottom of the outer edge of the flighting and the intersection of the bottom 30 and side wall 76 of the hopper if determined on the lower 360 degrees of rotation of the flighting (as in 200c). Partial channel 41 is defined as being bounded by central core 10 on the inside, lower surface 24 of the flighting 20 above on top, upper surface 22 of flighting below on the bottom and the guide portion 120b of the paddle arm 100b. The channel is partial because it is open between guide portion 120b and the outer edge 29 of the flighting below. The partial channel is only formed where a paddle is positioned. On all the other areas of the flighting 20, the space defined by the clearance distance is open.

The guide portion 120a of first paddle 100a and guide portion 120b of second paddle 100b each fill in some of the clearance distance, causing containment of material on the deck 22. Too much containment would lead to undesirable compression of material as it is lifted by the screw 1. Too little or no containment results in less efficient mixing because of material falling off the deck 22 before it reaches the top of the screw 1.

One important principle of the invention is that the paddle 100 forms a partial channel that balances several competing factors. First, the paddle 100 tends to keep material on the upper deck 22 of the flighting 20. Second, the paddle 100 may draw in additional material for optimal mixing. Third, the paddle allows some material to fall off the outer edge 29 of the flighting 20 in order to avoid compaction of material and clogging of the partial channel. The second and third factors are variable, depending on the configuration of the screw 1 and the materials to be mixed. For example, wetter materials may tend to clump and clog the partial channel more than drier materials, and therefore it may be beneficial to adjust the partial channel.

In addition, as referred to above, the paddle 100 may allow material to fall off the outer edge 29 of the flighting 20 in the partial channel to prevent clogging. The invention achieves this by angling guide portion 120 towards the outer edge 29 of the flighting below the attachment point, or the intersection of the bottom and side wall of the hopper in the lower 360 degrees of the flighting. Providing a bend in the guide portion may further aid this process.

Another principle is that the paddle 100 be of appropriate size to create an effective partial channel. That means that the guide portion 120 of the paddle 100 extend sufficiently downward, and the paddle 100 be long enough from the leading edge to the back end, to create an effective partial channel, based on the particular material being mixed. A shorter guide portion 120 may work well for longer materials such as hay or grass, whereas a longer guide portion may be needed for sufficient mixing of more flowable materials such as soybeans.

Accordingly, the leading edges of the paddle 100 are preferably designed, beveled and/or sharpened to prevent material from hanging up. The guide portion 120 of the paddle should cover a sufficient percentage of the clearance distance. The guide portion 120 of the paddle 100 may be angled or tilted to point towards the outer edge 29 of the flighting 20 below the attachment point, or the intersection of the bottom and side wall of the hopper in the lower 360 degrees of the flighting. The guide portion 120 may have a bend (as described below) to help prevent clogging of the partial channel. The paddle 100 may be adjustable to optimize mixing of differing combinations of materials. When more than one paddle 100 is used on a screw, each paddle may have its own configuration with respect to size, angle of the guide portion and attachment position.

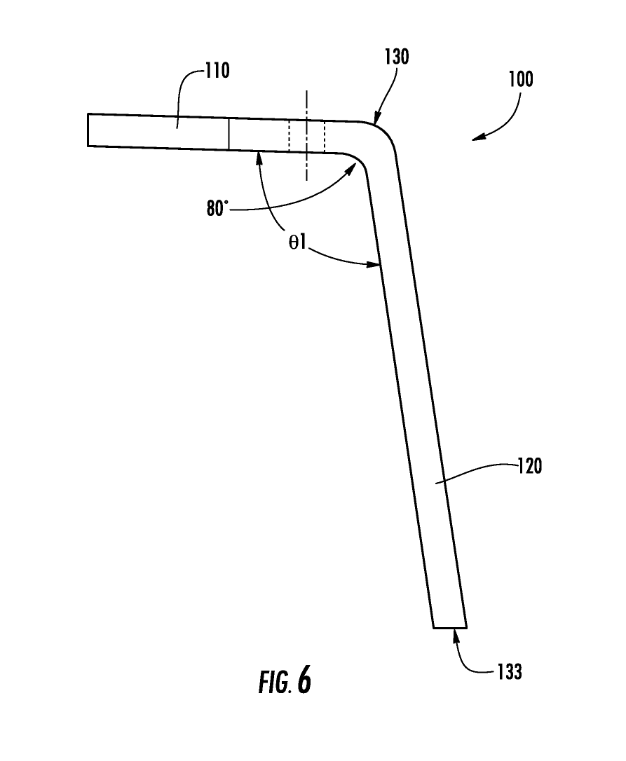

FIG. 6 is an end view of an embodiment of a paddle 100. As shown there, paddle 100 has a substantially attachment portion 110, a guide portion 120, an upper corner edge 130, and lower edge 133. In this first embodiment, the guide portion 120 is essentially planar and forms an angle ⊖1 with attachment portion 110. In one embodiment, angle ⊖1 is between about 90 and 130 degrees, and most preferably between about 95 and 100 degrees.

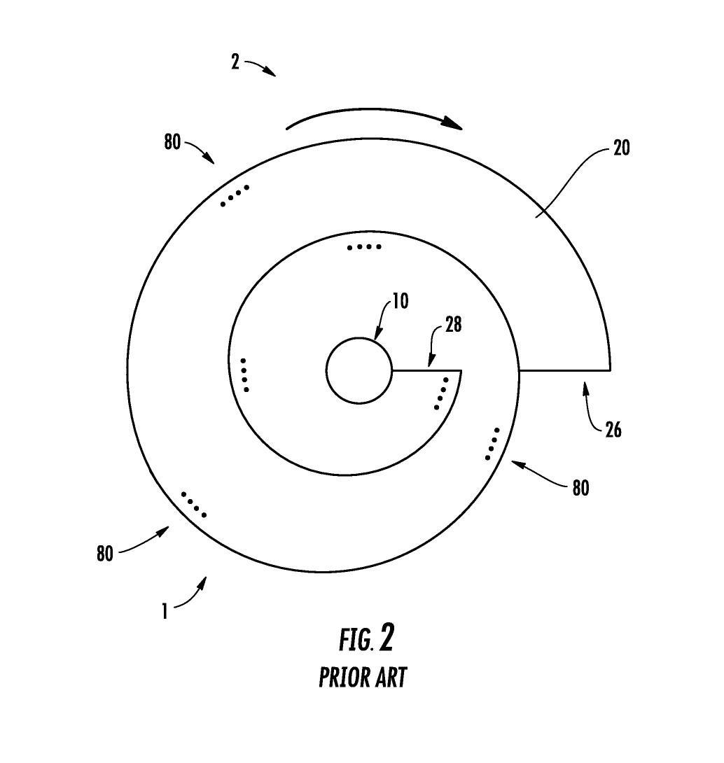

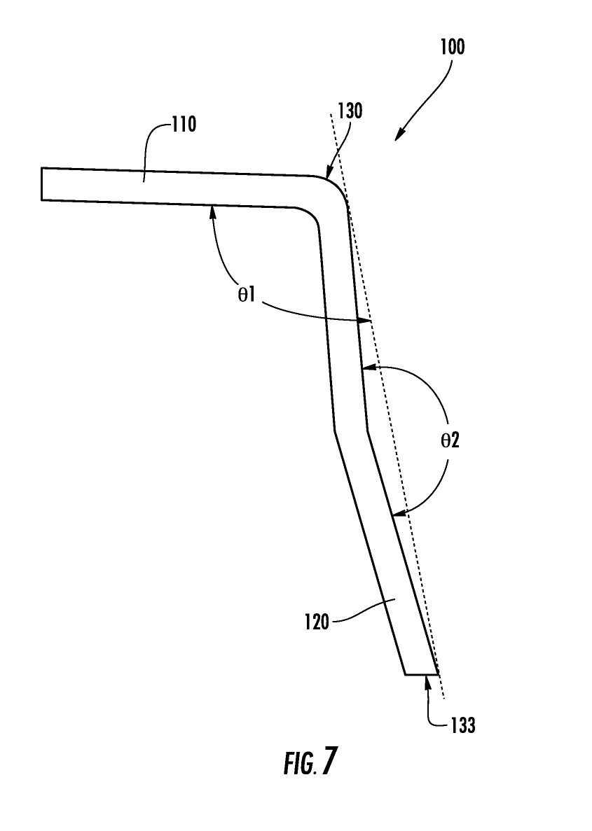

FIG. 7 is an end view of another embodiment of a paddle 100. As shown there, paddle 100 has an attachment portion 110 and a guide portion 120, and an upper corner edge 130 and a lower edge 133. As with the embodiment described above and shown in FIG. 6, the guide portion 120 is substantially planar and forms angle ⊖1 with attachment portion 110, and the angle ⊖1 is between about 90 and 130 degrees, and most preferably between about 95 and 100 degrees. In this embodiment, guide portion 120 is not as planar as the guide portion shown in FIG. 6, and includes a bend with angle ⊖2, such that the guide portion 120 is convex with respect to central core 10 of the screw 1 when the paddle 100 is attached to the screw. As shown in FIG. 2, in this embodiment, angle ⊖2 may be between 160 and 179 degrees.

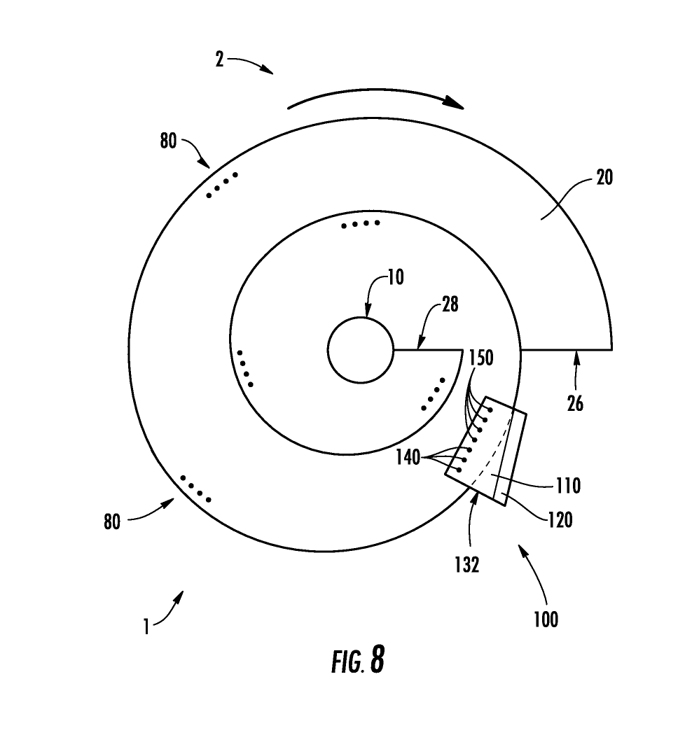

FIG. 8 shows a top view of a screw 1 with a paddle 100 attached. Paddle 100 is attached to screw 1 by bolts 150 that extend both through holes 140 in a screw attachment area 80 of screw 1 and holes in attachment portion 110 of paddle 100. Some of the holes 140 in the attachment portion 110 are unused. This figure illustrates the paddle arm 100 installed on the upper surface 22 of the flighting 20.

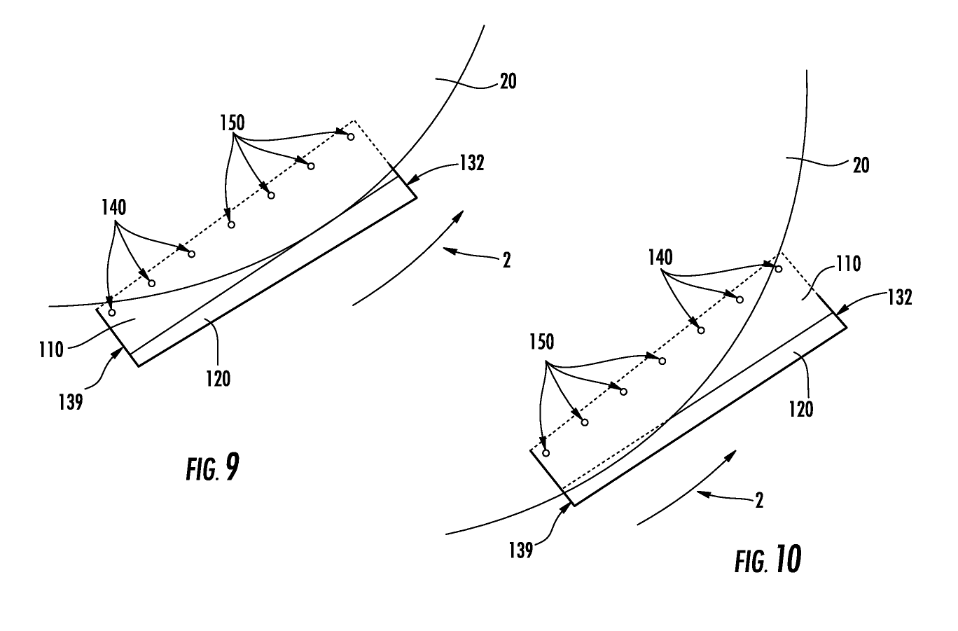

FIGS. 9 and 10 show the reverse rotation from FIG. 8, and show the adjustability of the paddle 100 in relation to the screw 1. To implement the adjustability feature, either or both the flighting 20 and the paddle 100 are provided with extra attachment holes 140 beyond the minimum number needed to secure the paddle to the screw. In FIG. 9, the paddle 100 is attached by bolts 150 as described in the paragraph above and certain of the holes 140 are unused. FIG. 10 illustrates the selection of different holes to secure the paddle 100 with bolts 150, thereby changing the configuration or positioning of the paddle in relation to the screw 1. Such adjustment may be desirable depending on clearance distance at the point of attachment, the materials to be mixed, and other factors.

In FIGS. 9 and 10, the paddle 100 is shown installed on the underside 24 of the flighting 20. While the invention may be practiced with the paddle arm 100 installed on the upper side 22 of the flighting 20, or even integrally formed or bonded with the flighting, attachment on the underside 24 offers several advantages. First, it minimizes hang up of material on the flighting deck compared to mounting on the upper side 22. Second, it allows for greater ease of adjustability, as mounting the paddle 100 on the upper side 22 could be complicated by the requirement of avoiding interference between the paddle and the outer edge 29 of the flighting 20.

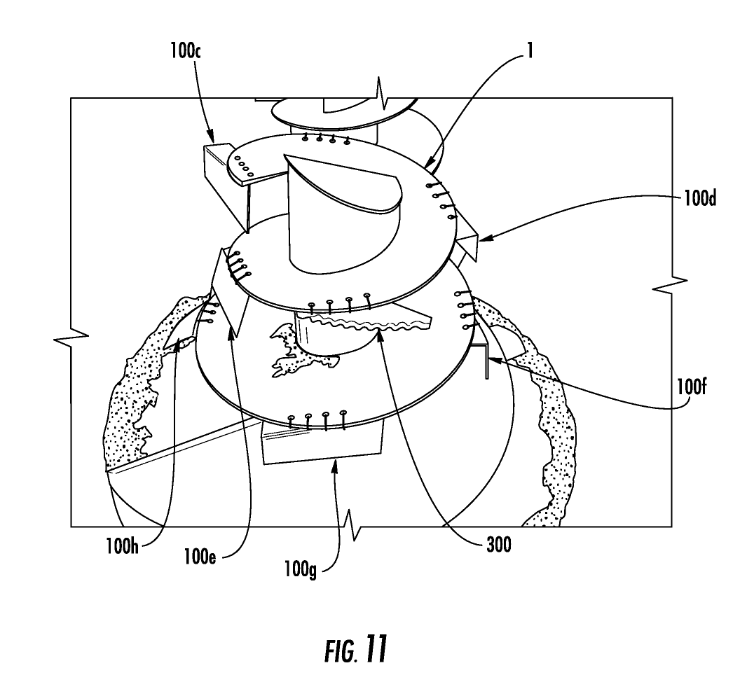

FIG. 11 illustrates attachment of multiple paddles 100 to a single screw 1. Paddles 100c, 100d, 100e, 100f, 100g, 100h are simultaneously attached to screw 1. This drawing figure illustrates how the design and installation of the paddle can be adapted and varied for particular purposes. For example, paddle 100c is positioned at an attachment site 80 whose outer edge is almost directly above the outer edge of the flighting below. Therefore angle ⊖1 for paddle 100c is close to 90 degrees. In contrast, angle ⊖1 of paddle 100e is greater because of the relative position of the outer edge of the flighting below. Accounting for this variable may lead to different paddle designs. Also, it can be seen that paddle 100c is positioned to draw in more material to the flighting deck than paddle 100e. Accounting for this variable may lead to an alternative attachment of the paddle 100 to the screw 1. FIG. 11 also illustrates the attachment of a knife 300 to the screw 1.

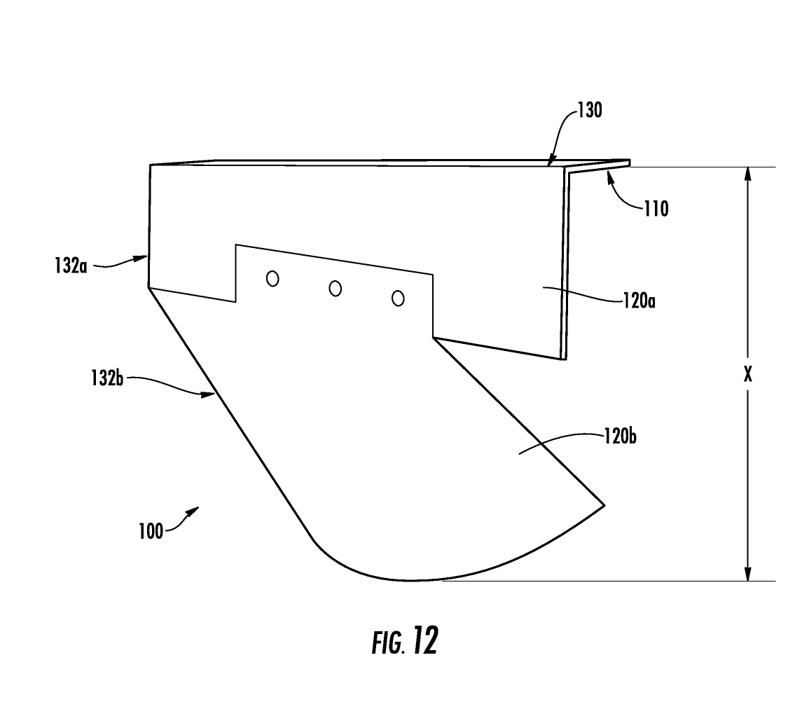

FIG. 12 depicts an alternative embodiment of the guide portion 120 of the paddle 100. The guide portion 120 of the paddle 100 is not limited to rectangular configurations. Alternative embodiments are also within the scope of the invention. Such alternative embodiments may contribute additional functionality, such as the knife 300 shown in FIG. 11. In this embodiment, the guide portion 120 includes two components 120a and 120b, with two leading edges 132a and 132b. In an embodiment where the height of the guide portion 120 is not uniform, such as that shown in FIG. 12, the height is the distance between upper corner 130 and the lowest portion of the guide portion 120 that substantially contributes to forming a partial channel. In FIG. 12, the height is x.

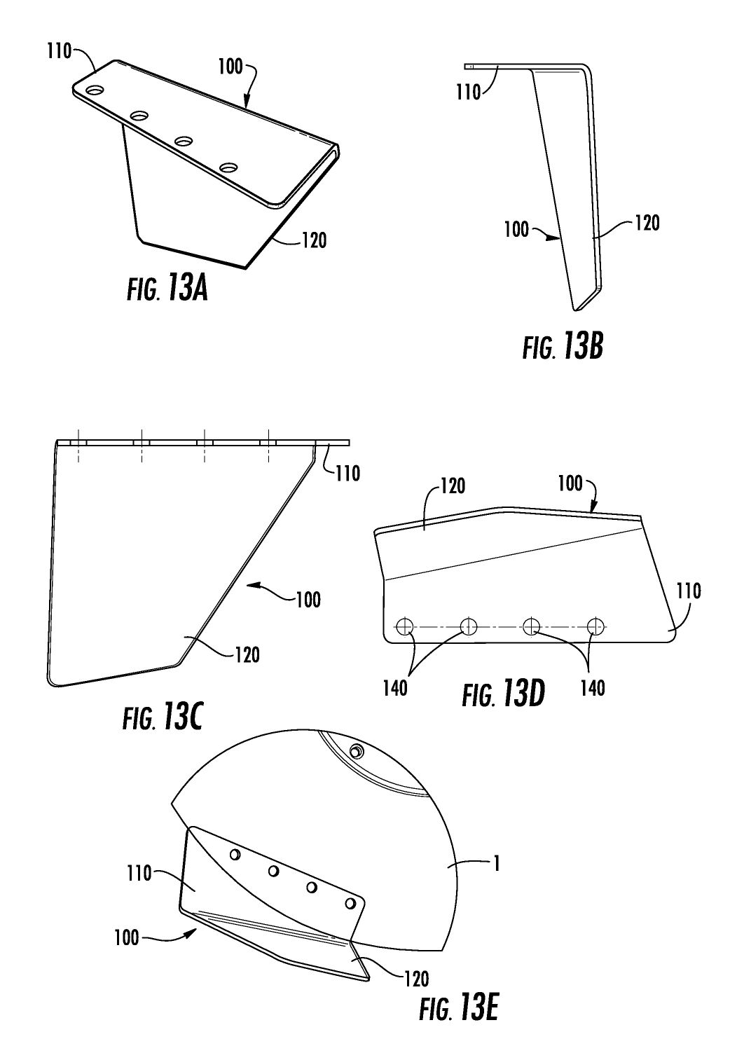

FIGS. 13 through 17 show other alternative embodiments of the paddle 100. FIGS. 13A through 13E show a paddle embodiment where substantially all of the guide portion 120 of the paddle 100 is substantially planar, and the attachment portion 110 is also substantially planar, but trapezoidal in shape, similar to the embodiment shown in FIGS. 4 and 6. Attachment portion 110 includes four simple holes 140 for attaching the paddle 100 to the screw 1. In this embodiment, guide portion 120 is cut off at an angle, rather than being substantially a rectangle or parallelogram as is the one shown in FIG. 4.

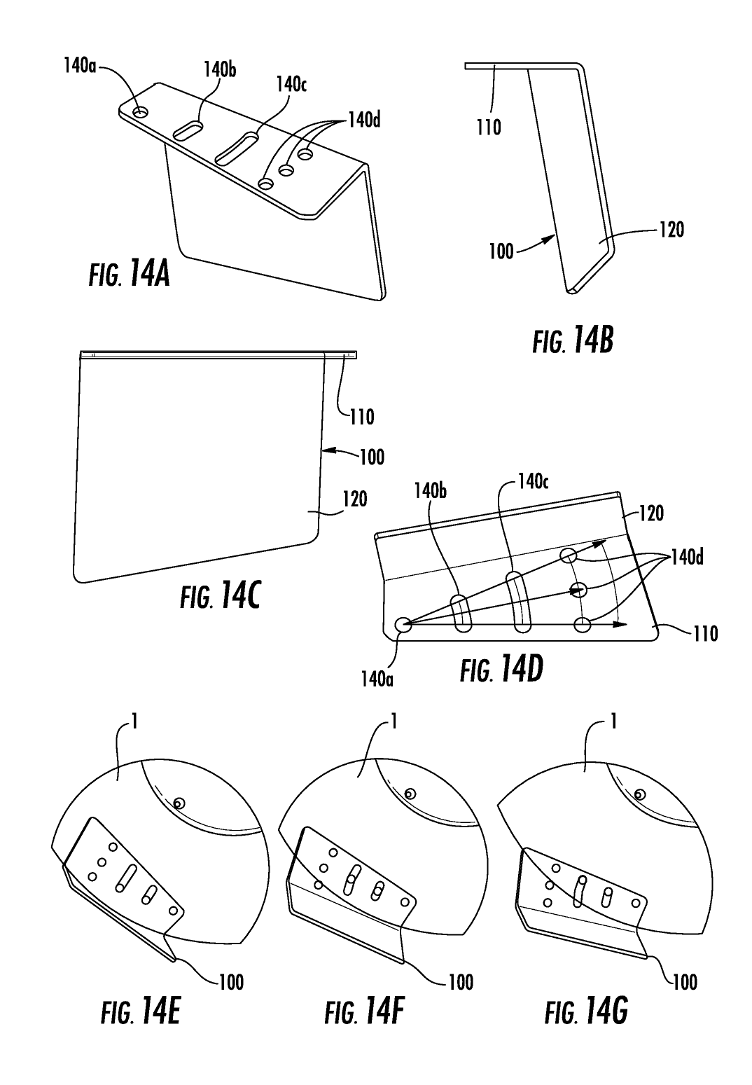

FIGS. 14A through 14G shown a paddle embodiment where the attachment portion 110 and the guide portion 120 are substantially the same as that shown in FIGS. 4 and 6. The difference is that, in FIGS. 14A through 14G, the attachment portion 110 includes a different hole arrangement for attaching the paddle 100 to the screw 1. In this embodiment, a single hole 140a is provided at the narrow end of the trapezoidal attachment portion 110. Then, two curved slots 140b and 140c are provided at the same respective separations from the single hole 140a as the second and third holes 140 in FIGS. 13A through 13E. For each of the curved slots 140b and 140c, the radius of the slot curvature is about the distance from the center of the respective slot opening to the center of the single hole 140a. At the area of the trapezoidal attachment portion 110 distal from the single hole 140 are provided several attachment holes 140d, three in the embodiment shown. The effect of this arrangement of the single hole 140a, curved slots 140b and 140c and several attachment holes 140d can be seen by comparing FIGS. 14E, 14F and 14G, where it can be seen that, assuming the screw 1 has a single, straight line of apertures 80, the paddle 100 of FIGS. 14A through 14G can be mounted at several different angles, so as to pull more, or less, as desired, of the feed onto the deck of the screw. FIG. 14E shows the paddle 100 rotated to its least extent. FIG. 14F shows the paddle 100 rotated to an intermediate extent. And FIG. 14G shows the paddle 100 rotated to its greatest extent, using the mounting holes 140a and 140d, and slots 140b and 140c. The maximum angle between the different positions of the mounting of the paddle 100 in these figures is shown to be angle ρ. This concept of curved slots and multiple mounting holes can be applied to any of the embodiments disclosed herein.

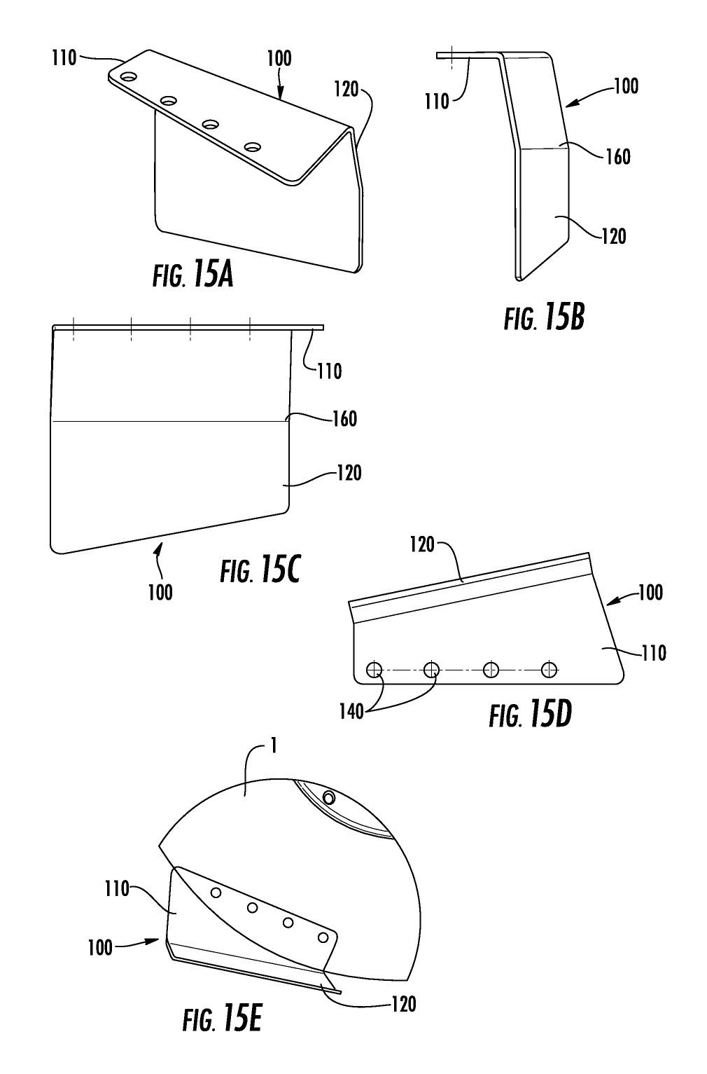

FIGS. 15A through 15E show an embodiment of the invention where the attachment portion 110 of the paddle 100 is substantially planar and trapezoidal in shape. In these FIGS. 15A through 15E, the guide portion 120 is non-planar, in a sense similar to the embodiment shown in FIG. 7. Here, however, the guide portion 120 has a bend 160 that causes the side of the guide portion facing the attachment portion to be concave, rather than convex, as shown in FIG. 7.

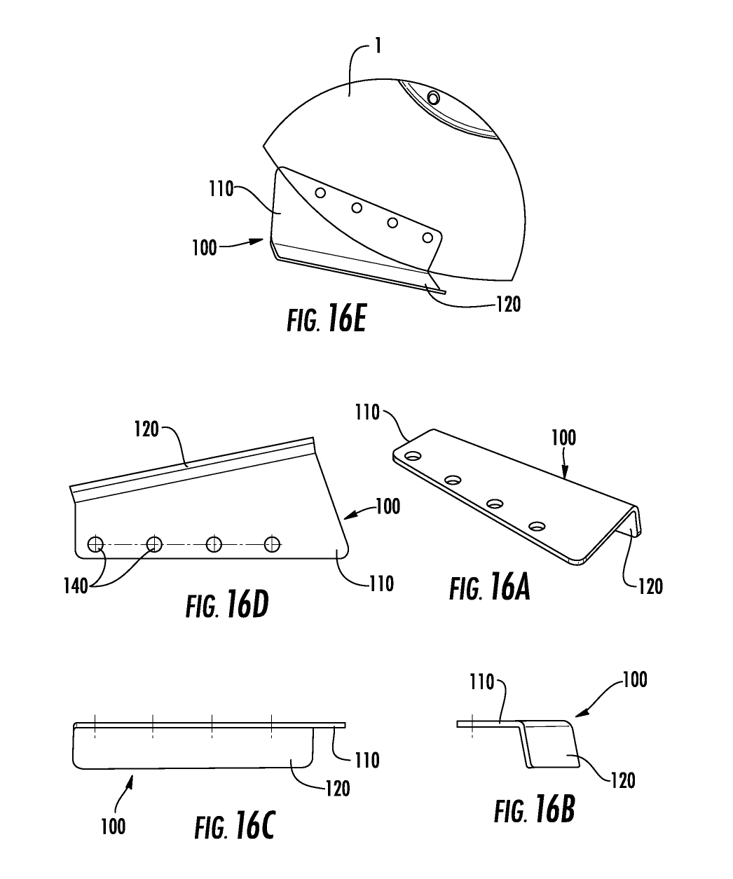

FIGS. 16A through 16E show an embodiment of the invention where the attachment portion 110 of the paddle 100 is substantially planar and trapezoidal in shape, but where the guide portion 120 is much shorter in length than the embodiments shown heretofore. As indicated above, the benefit of such a configuration is the usefulness with longer materials such as hay or grass.

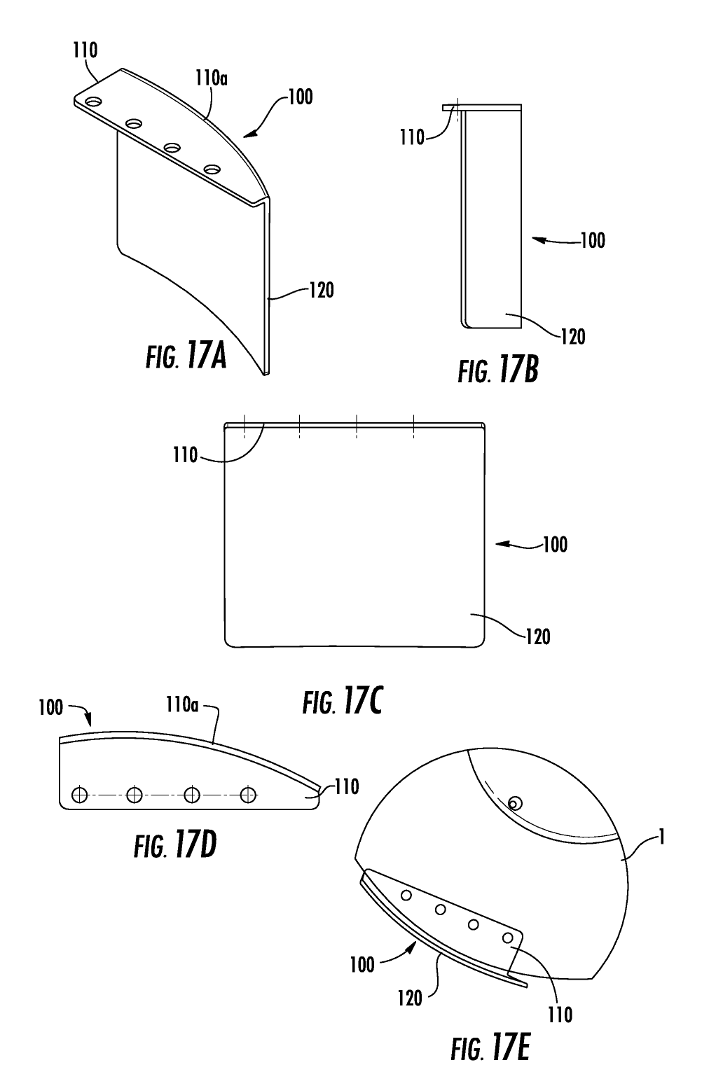

FIGS. 17A through 17E show an embodiment of the invention where the attachment portion 110 of the paddle 100 is substantially planar in shape, but not trapezoidal. Rather, one edge 110a of the attachment portion 110 forms a smooth curve, such as a radiused curve. The radius of the curve may approximate the radius of the edge of the flighting 20 of the screw 1. Correspondingly, the guide portion 120 attaches or connects along that smoothly curved edge, and itself forms a smoothly curved shape, in this case generally a cylindrical arc, again with the center line of the cylindrical arc approximately coinciding with the center line of the central core 10, and again for the purpose of improving the performance of the paddle 100 by permitting it to more smoothly and efficiently draw feed onto the deck of the screw, so as to improve the mixing performance.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. In a mixer having one or more substantially vertically oriented screws, each screw having a central core and one or more flightings, with each flighting having an upper surface and a lower surface, and where the flighting has a leading lower edge and a trailing upper edge, an improvement comprising:
a paddle mounted to a portion of the flighting, and having a guide portion extending below the lower surface of the portion of the flighting to which the paddle is attached.

2. The combination of claim 1, wherein the paddle includes an attachment portion connected to the guide portion and capable of being connected to the flighting.

3. The combination of claim 2, wherein the guide portion is substantially planar.

4. The combination of claim 2, wherein the guide portion includes a bend, resulting in a convex side and a concave side.

5. The combination of claim 4, wherein the convex side of the guide portion is oriented towards the central core.

6. The combination of claim 2, wherein the attachment portion comprises a series of holes, and the number of holes is greater than a number needed to securely attach the paddle to the screw.

7. The combination of claim 6, wherein the series of holes is arranged in a substantially linear arrangement.

8. A feed mixer comprising:
a mixing chamber;
a substantially vertically oriented screw rotatably mounted within the tub, and having a central core and one or more flightings, each flighting having an upper surface and a lower surface, and where the flighting has a leading lower edge and a trailing upper edge, and
a paddle with a guide portion extending below the lower surface of the flighting.

9. The feed mixer of claim 8, wherein the paddle includes an attachment portion connected to the guide portion and capable of being connected to the flighting.

10. The feed mixer of claim 8, wherein the guide portion is substantially planar.

11. The feed mixer of claim 8, wherein the guide portion includes a bend, resulting in a convex side and a concave side.

12. The feed mixer of claim 11, wherein the convex side of the guide portion is oriented towards the central core.

13. The feed mixer of claim 9, wherein the attachment portion comprises a series of holes, and the number of holes is greater than a number needed to securely attach the paddle to the screw.

14. The feed mixer of claim 13, wherein the series of holes is arranged in a substantially linear arrangement.

15. A paddle for use with a feed mixer having a mixing chamber and a substantially vertically oriented screw rotatably mounted within the tub, and having a central core and one or more flightings, each flighting having an upper surface and a lower surface, and where the flighting has a leading lower edge and a trailing upper edge, the paddle comprising:
an attachment portion capable of being attached to the flighting; and
a guide portion connected to the attachment portion and extending below the lower surface of the flighting.

16. The paddle of claim 15, wherein the attachment portion includes a plurality of openings by which the paddle is connected to the flighting by use of fasteners.

17. The paddle of claim 15, wherein the guide portion is substantially planar.

18. The paddle of claim 15, wherein the guide portion includes a bend, resulting in the guide portion having a convex side and a concave side.

19. The paddle of claim 18, wherein the convex side of the guide portion is oriented towards the central core.

20. The paddle of claim 18, wherein the convex side of the guide portion is oriented away from the central core.

21. The paddle of claim 16, wherein the openings include slots to enable to the paddle to be positioned in different positions.

22. The paddle of claim 16, wherein the openings are arranged in a substantially linear arrangement.
